(19) United States
(12) Patent Application Publication
(10) Pub. No.: US 2023/0128570 A1
(43) Pub. Date: Apr. 27, 2023

(54) INFORMATION PROCESSING APPARATUS, NON-TRANSITORY COMPUTER READABLE MEDIUM, AND INFORMATION PROCESSING METHOD

(71) Applicant: FUJIFILM BUSINESS INNOVATION CORP., Tokyo (JP)

(72) Inventor: Saneyuki KOBAYASHI, Kanagawa (JP)

(73) Assignee: FUJIFILM BUSINESS INNOVATION CORP., Tokyo (JP)

(21) Appl. No.: 17/861,354

(22) Filed: Jul. 11, 2022

(30) Foreign Application Priority Data
Oct. 21, 2021 (JP) 2021-172377

(51) Int. Cl. G06F 40/137; G06F 40/166

(52) U.S. Cl. CPC G06F 40/137; G06F 40/166

(57) ABSTRACT

An information processing apparatus includes a processor configured to, in response to change to multiple parts in a document having a hierarchical structure, regard, as a change scope, a hierarchy containing the parts, and determine a change candidate that is to be changed in another document different from the document.

### CROSS-REFERENCE TO RELATED APPLICATIONS

This application is based on and claims priority under 35 USC 119 from Japanese Patent Application No. 2021-172377 filed Oct. 21, 2021.

### BACKGROUND

### (i) Technical Field

The present disclosure relates to an information processing apparatus, a non-transitory computer readable medium, and an information processing method.

### (ii) Related Art

Japanese Unexamined Patent Application Publication No. 6-309316 discloses a document generating apparatus which sets any tag names to marks for explicitly pointing out revised parts in a document. The document generating apparatus may search a document by using a tag name to extract a revised part to which the tag name is set.

The case in which, when a document is changed, change candidates in the other documents different from the changed document are determined will be discussed. Assume that change candidates in the other documents are determined by regarding, as change scopes, only parts limited to the actual changes in the document. In this case, parts which need to be changed in the other documents may be left out from the change candidates.

### SUMMARY

Aspects of non-limiting embodiments of the present disclosure relate to a technique which achieves the following effect compared with the case in which only parts limited to actual changes in a document are regarded as change scopes: when change candidates in the other documents are determined on the basis of a change scope, fewer parts are left out from the change candidates.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to, in response to change to multiple parts in a document having a hierarchical structure, regard, as a change scope, a hierarchy containing the parts, and determine a change candidate that is to be changed in another document different from the document.

### BRIEF DESCRIPTION OF THE DRAWINGS

Exemplary embodiments of the present disclosure will be described in detail based on the following figures, wherein:

FIG. 1 is a diagram illustrating an exemplary configuration of an information processing system to which the present exemplary embodiment is applied;

FIG. 2 is a diagram illustrating an exemplary hardware configuration of an information processing apparatus to which the present exemplary embodiment is applied;

FIG. 3 is a block diagram illustrating a functional example implemented by an information processing apparatus to which the present exemplary embodiment is applied;

FIG. 4 is a diagram illustrating manual X which is an exemplary changed document obtained by a change-scope determination unit;

FIG. 5 is a diagram illustrating an exemplary change history which is stored in a change-history storage unit and which is obtained by a change-candidate determination unit;

FIG. 6 is a diagram illustrating an exemplary display screen displayed on a display device of a terminal apparatus on the basis of output from a change-candidate output unit;

FIG. 7 is a diagram illustrating manual X which is an exemplary changed document obtained by a change-scope determination unit;

FIG. 8 is a diagram illustrating an exemplary replacement table obtained by a change-scope determination unit; and

FIG. 9 is a diagram for describing a process, which is performed by a change-scope determination unit, according to a fourth exemplary embodiment.

### DETAILED DESCRIPTION

### First Exemplary Embodiment

Referring to the attached drawings, exemplary embodiment of the present disclosure will be described below.

### Information Processing System 1

When one document among multiple documents, which are related to each other, is changed, an information processing system 1 according to a first exemplary embodiment is used to determine change candidates, to which change is to be made in the other documents, on the basis of the change to the document.

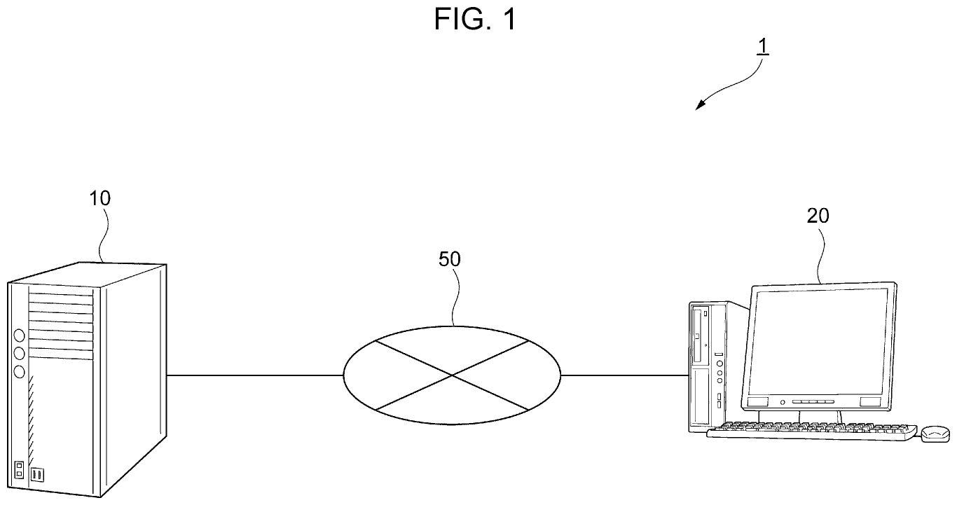

FIG. 1 is a diagram illustrating an exemplary configuration of the information processing system 1 to which the first exemplary embodiment is applied. As illustrated in FIG. 1, the information processing system 1 includes an information processing apparatus 10 which processes documents, and a terminal apparatus 20 which is connected to the information processing apparatus 10. In the information processing system 1, the information processing apparatus 10 is connected to the terminal apparatus 20 through a communication line 50 such as an Internet line. In the information processing system 1 illustrated in FIG. 1, the information processing apparatus 10 is connected to a single terminal apparatus 20. Alternatively, the information processing apparatus 10 may be connected to multiple terminal apparatuses 20.

The terminal apparatus 20 is a computer operated by a user who uses the information processing system 1. Additionally, the terminal apparatus 20 is a computer operated by a user when documents managed by the information processing apparatus 10 are to be changed. The terminal apparatus 20 is, for example, formed of a personal computer (PC).

The terminal apparatus 20 is formed of a central processing unit (CPU), a read only memory (ROM), and a random access memory (RAM) which are not illustrated, and includes an information processor which processes information. The terminal apparatus 20 also includes a storage unit which stores information, and a communication interface which performs communication. Further, the terminal apparatus 20 includes a receiving device which receives operations performed by a user, and a display device which displays information.

### Information Processing Apparatus 10

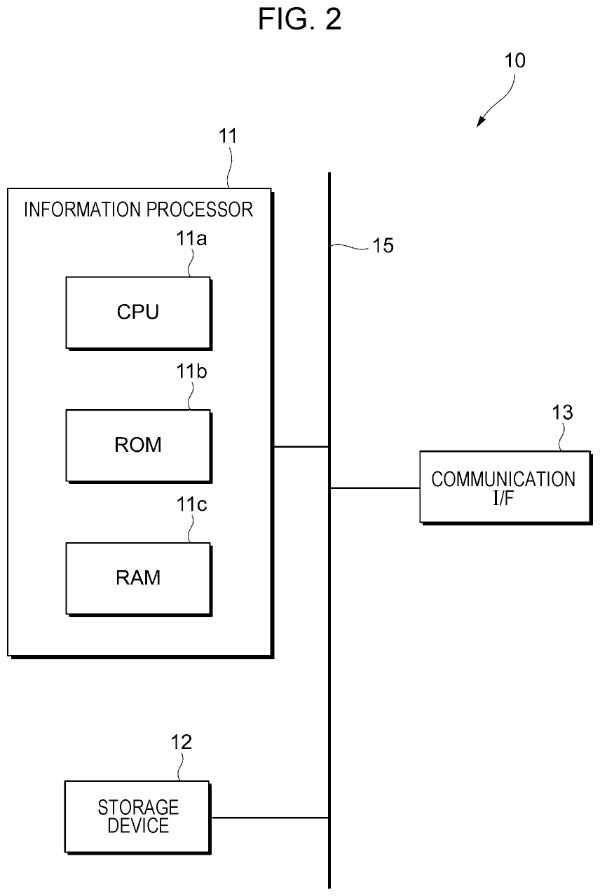

The hardware configuration of the information processing apparatus 10 will be described. FIG. 2 is a diagram illustrating an exemplary hardware configuration of the information processing apparatus 10 to which the first exemplary embodiment is applied.

As illustrated in FIG. 2, the information processing apparatus 10 includes an information processor 11 which processes information, a storage device 12 which stores information, and a communication interface (communication I/F) 13 which performs communication. In the information processing apparatus 10, the information processor 11, the storage device 12, and the communication I/F 13 are connected to a bus 15, and receives/transmits data through the bus 15.

As illustrated in FIG. 2, the information processor 11 is formed of a CPU 11a, a ROM 11b, and a RAM 11c.

The CPU 11a, which is an exemplary processor, loads various programs, which are stored, for example, in the ROM 11b and the storage device 12, to the RAM 11c for execution to implement functions described below. The RAM 11c is a memory used, for example, as a work memory of the CPU 11a. The ROM 11b is a memory for storing, for example, various programs executed by the CPU 11a.

Programs executed by the CPU 11a may be provided to the terminal apparatus 20 by storing the programs, for example, in a computer-readable recording medium, such as a magnetic recording medium (e.g., a magnetic tape or a magnetic disk), an optical recording medium (e.g., an optical disk), a magneto-optical recording medium, or a semiconductor memory. Alternatively, programs executed by the CPU 11a may be provided to the terminal apparatus 20 by using a communication unit such as the Internet.

In the first exemplary embodiment, the term “processor” refers to hardware in a broad sense. Examples of the processor include general processors (e.g., CPU) and dedicated processors (e.g., GPU: Graphics Processing Unit, ASIC: Application Specific Integrated Circuit, FPGA: Field Programmable Gate Array, and programmable logic device).

In the first exemplary embodiment, the term “processor” is broad enough to encompass one processor or plural processors in collaboration which are located physically apart from each other but may work cooperatively. The order of operations of the processor is not limited to one described in the embodiments above, and may be changed.

The storage device 12, which is an exemplary memory, is formed, for example, of a hard disk drive (HDD), and stores various data.

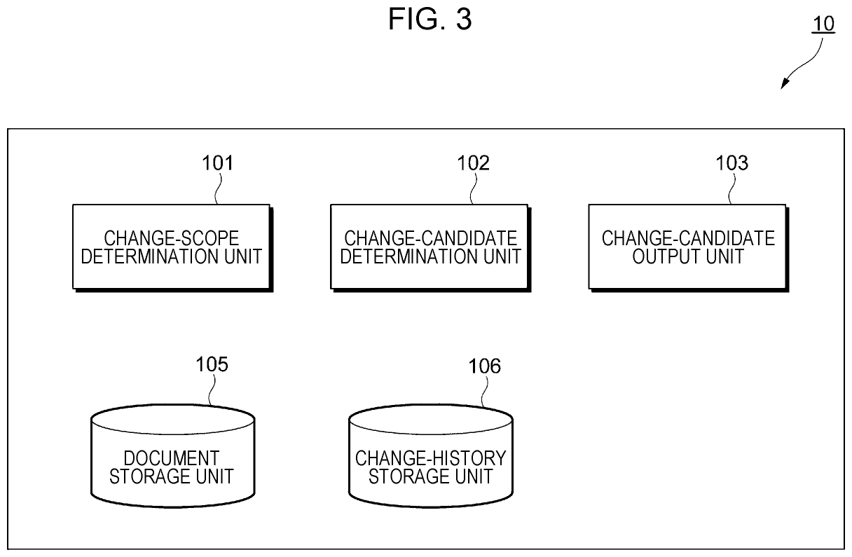

The functional configuration of the information processing apparatus 10 will be described. FIG. 3 is a block diagram illustrating a functional example implemented by the information processing apparatus 10 to which the first exemplary embodiments is applied.

As illustrated in FIG. 3, the information processing apparatus 10 includes a change-scope determination unit 101 which determines a change scope in a document received from the terminal apparatus 20, a change-candidate determination unit 102 which determines change candidates in the other documents related to the document in which the change-scope determination unit 101 has determined the change scope, and a change-candidate output unit 103 which notifies the change candidates determined by the change-candidate determination unit 102. The information processing apparatus 10 also includes a document storage unit 105 which stores multiple documents that are to be changed by a user who operates the terminal apparatus 20, and a change-history storage unit 106 which stores the change history for the documents stored in the document storage unit 105.

In the information processing apparatus 10, the change-scope determination unit 101, the change-candidate determination unit 102, and the change-candidate output unit 103 are implemented by the CPU 11a which executes programs stored in the ROM 11b and the storage device 12. The document storage unit 105 and the change-history storage unit 106 are implemented by the storage device 12.

The document storage unit 105 stores multiple documents. A document herein is electronic data having a predetermined format, and is, for example, text data, numeric-value data, graphics data, image data, movie data, or audio data.

The documents stored in the document storage unit 105 include documents having hierarchical structures. A document having a hierarchical structure means a document in which elements, included in the document, form a hierarchy from top to bottom. An Example of such a document having a hierarchical structure is a structured document in Hypertext Markup Language (HTML) format or Extensible Markup Language (XML) format in which its hierarchical structure is specified by tags. A document having a hierarchical structure is text data such as the text of a law or a paper having a hierarchical structure, for example, comprised of chapters, articles, sections, and items. A document having a hierarchical structure is table data having multiple rows and columns. Table data has a hierarchy, for example, formed of a table, rows and columns, cells in the rows and columns, and characters in the cells. Documents having hierarchical structures are not limited to the documents given as examples herein.

Every time the content of each document stored in the document storage unit 105 is changed, the change-history storage unit 106 stores a change history record which is information about the change. A change of the content of a document means that the document is changed to a state different from that before the change. Examples of the change include, but not limited to, deletion, addition, and modification of an element in the document.

When changes to multiple documents stored in the document storage unit 105 are related to each other, the change-history storage unit 106 stores the changed parts of the multiple documents in association with each other. Additionally, when a part changed in a document among multiple documents is related to a part changed in another document, the change-history storage unit 106 stores these parts in association with each other.

Examples of the case in which changes to multiple documents are related to each other include the case in which the documents are changed at the same time, the case in which the documents are changed by the same user, and the case in which the documents are changed by using the same source data.

Examples of the case in which multiple documents are changed at the same time include the case in which the documents are changed in a predetermined period, and the case in which, after one of the documents is changed, other documents are changed continuously without another action.

The change-scope determination unit 101 determines a change scope when multiple parts are changed in a document, having a hierarchical structure, among the documents stored in the document storage unit 105. Specifically, when multiple parts are changed in a document having a hierarchical structure, the change-scope determination unit 101 according to the first exemplary embodiment regards, as a change scope, a hierarchy containing the changed parts.

The process performed by the change-scope determination unit 101 will be described in detail by using an example below.

On the basis of the change scope determined by the change-scope determination unit 101 and the change history for the documents stored in the change-history storage unit 106, the change-candidate determination unit 102 determines change candidates in documents other than the document, for which the change scope has been determined by the change-scope determination unit 101, among the documents stored in the document storage unit 105.

The change candidates determined by the change-candidate determination unit 102 indicate scopes in which, when the document is changed in the change scope determined by the change-scope determination unit 101, changes may need to be made in the other documents. Additionally, the change-candidate determination unit 102 determines, as change candidates, parts, in the other documents, which are associated, in the change history stored in the change-history storage unit 106, with the change scope determined by the change-scope determination unit 101 in the document.

The change-candidate output unit 103 notifies, for example, the terminal apparatus 20 of the change candidates, in the other documents, which are determined by the change-candidate determination unit 102.

### The Process Performed by the Information Processing Apparatus 10

The process performed by the information processing apparatus 10 will be described specifically.

The document storage unit 105 stores, as the multiple documents, manual X, manual Y, and manual Z which are described in XML format and which have hierarchical structures. The case in which a user uses the terminal apparatus 20 to change manual X will be described as an example.

### The Process Performed by the Change-Scope Determination Unit 101

When a user uses the terminal apparatus 20 to change a document among the documents stored in the document storage unit 105, the change-scope determination unit 101 obtains the changed document from the terminal apparatus 20. In this example, the change-scope determination unit 101 obtains manual X, which has been changed, as a changed document from the terminal apparatus 20.

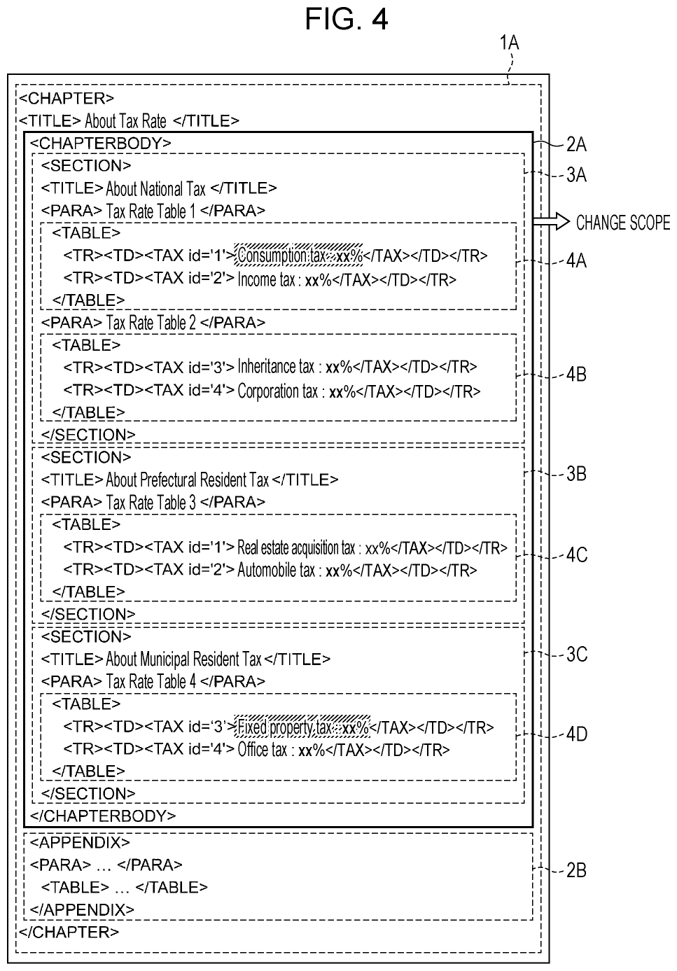

FIG. 4 is a diagram illustrating manual X which is an exemplary changed document obtained by the change-scope determination unit 101.

As illustrated in FIG. 4, manual X is a structured document which is described in XML format and which has a hierarchical structure. Manual X has a hierarchical structure described by using multiple tags.

More specifically, manual X has CHAPTER 1A (About Tax Rate) as the uppermost hierarchy. Manual X also has CHAPTERBODY 2A and APPENDIX 2B as lower hierarchies contained in CHAPTER 1A. Further, manual X has SECTION 3A (About National Tax), SECTION 3B (About Prefectural Resident Tax), and SECTION 3C (About Municipal Resident Tax) as lower hierarchies contained in CHAPTERBODY 2A.

In addition, manual X has TABLE 4A (Tax Rate Table 1) and TABLE 4B (Tax Rate Table 2) as lower hierarchies contained in SECTION 3A. TABLE 4A contains elements of “consumption tax: xx %” and “income tax: xx %”; TABLE 4B contains elements of “inheritance tax: xx %” and “corporation tax: xx %”.

In addition, manual X has TABLE 4C (Tax Rate Table 3) as a lower hierarchy contained in SECTION 3B. TABLE 4C contains elements of “real estate acquisition tax: xx %” and “automobile tax: xx %”.

Further, manual X has TABLE 4D (Tax Rate Table 4) as a lower hierarchy contained in SECTION 3C. TABLE 4D contains elements of “fixed property tax: xx %” and “office tax: xx %”.

In this example, it is assumed that, in manual X, “consumption tax: xx %” in TABLE 4A and “fixed property tax: xx %” in TABLE 4D, which are illustrated with a hatched pattern in FIG. 4, are parts which have been changed by a user by using the terminal apparatus 20.

As described above, when multiple parts have been changed in a document having a hierarchical structure, the change-scope determination unit 101 determines, as a change scope, a hierarchy containing the changed parts.

In this example, when the changed parts are contained in multiple hierarchies, the change-scope determination unit 101 determines, as a change scope, the lowest hierarchy which is the lowest among the hierarchies containing the changed parts.

As illustrated in FIG. 4, manual X has CHAPTER 1A and CHAPTERBODY 2A as hierarchies containing both “consumption tax: xx %” in TABLE 4A and “fixed property tax: xx %” in TABLE 4D which are changed parts.

In this example, the change-scope determination unit 101 determines, as the change scope of manual X, CHAPTERBODY 2A which is the lowest hierarchy among CHAPTER 1A and CHAPTERBODY 2A which are hierarchies containing the changed parts.

The change-scope determination unit 101 outputs the determined change scope to the change-candidate determination unit 102. In this example, the change-scope determination unit 101 outputs CHAPTERBODY 2A as the change scope of manual X to the change-candidate determination unit 102.

### The Process Performed by the Change-Candidate Determination Unit 102

The change-candidate determination unit 102 obtains the change scope, which has been determined by the change-scope determination unit 101, of a document stored in the document storage unit 105.

The change-candidate determination unit 102 obtains the change history for the documents, including the document for which the change scope has been obtained, from the change-history storage unit 106.

The change-candidate determination unit 102 determines change candidates on the basis of the change scope of the document, which is obtained from the change-scope determination unit 101, and the change history, which is obtained from the change-history storage unit 106, for the documents including the document. The determined change candidates indicate potential changes which may be made in the other documents different from the document.

In this example, the change-candidate determination unit 102 obtains CHAPTERBODY 2A as the change scope of manual X.

The change-candidate determination unit 102 obtains, from the change-history storage unit 106, the change history between manual X which is the document for which the change scope has been obtained, and manuals Y and Z which are the other documents.

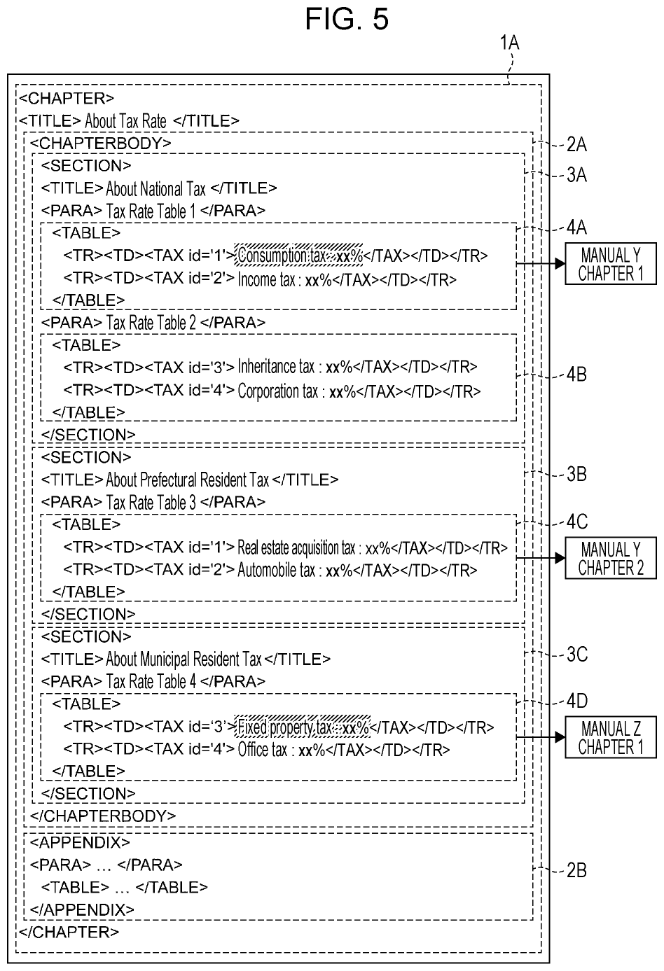

FIG. 5 is a diagram illustrating an exemplary change history which is stored in the change-history storage unit 106 and which is obtained by the change-candidate determination unit 102, and illustrating parts of manual Y and manual Z, which are associated with parts of manual X on the basis of past changes to manual X, manual Y, and manual Z.

For example, it is assumed that, at the same time at which TABLE 4A and TABLE 4D of manual X were changed, CHAPTER 1 (not illustrated) of manual Y and CHAPTER 1 (not illustrated) of manual Z were changed; at the same time at which TABLE 4C of manual X was changed, CHAPTER 2 (not illustrated) of manual Y was changed. In this case, as illustrated in FIG. 5, the change history describes association between TABLE 4A of manual X and CHAPTER 1 of manual Y, association between TABLE 4C of manual X and CHAPTER 2 of manual Y, and association between TABLE 4D of manual X and CHAPTER 1 of manual Z.

On the basis of the change scope of manual X obtained from the change-scope determination unit 101 and the change history for manual X, manual Y, and manual Z which is obtained from the change-history storage unit 106, the change-candidate determination unit 102 determines change candidates to which changes may be made in manual Y and manual Z.

In this example, the change-candidate determination unit 102 determines, as change candidates, the scopes, in manual Y and manual Z, associated with CHAPTERBODY 2A of manual X and the lower hierarchies, which are contained in CHAPTERBODY 2A, in the change history. Specifically, the change-candidate determination unit 102 determines, as change candidates, CHAPTER 1 of manual Y associated with TABLE 4A contained in CHAPTERBODY 2A of manual X, CHAPTER 2 of manual Y associated with TABLE 4C, and CHAPTER 1 of manual Z associated with TABLE 4D.

As described above, in the information processing apparatus 10 according to the first exemplary embodiment, when multiple parts are changed in a document having a hierarchical structure, the change-scope determination unit 101 regards, as a change scope, the scope in which the changed parts are contained, and the change-candidate determination unit 102 determines change candidates, to which changes are to be made in the other documents, on the basis of the change scope.

The following case which is different from the first exemplary embodiment will be discussed: when multiple parts are changed in a document having a hierarchical structure, only each changed part is regarded as a change scope or only each hierarchy containing its corresponding changed part is regarded as a change scope. In this case, if there is a part, which is to be changed, in the other documents, such a part may be left out from the change candidates.

In the example in FIGS. 4 and 5, when only each hierarchy containing its corresponding part changed in manual X is regarded as a change scope, TABLE 4A containing “consumption tax: xx %” and TABLE 4D containing “fixed property tax: xx %” are determined as change scopes. In contrast, TABLE 4B and TABLE 4C which do not contain changed parts are not determined as change scopes.

In this case, CHAPTER 1 of manual Y which is associated with TABLE 4A of manual X and CHAPTER 1 of manual Z which is associated with TABLE 4D of manual X are determined as change candidates, while CHAPTER 2 of manual Y which is associated with TABLE 4C of manual X is not determined as a change candidate. That is, some parts are easily left out from the change candidates of manual Y and manual Z which are determined on the basis of the changes to manual X.

In contrast, in the first exemplary embodiment, when multiple parts are changed in a document having a hierarchical structure, a scope containing the changed parts is regarded as a change scope. Thus, compared with the case in which only each changed part is regarded as a change scope and the case in which only each hierarchy containing its corresponding changed part is regarded as a change scope, the scope in which change candidates are determined in the other documents is wider. This suppresses occurrence of the state in which parts, which need to be changed in the other documents, are left out from the change candidates.

In determination of change candidates in the other documents based on the change scope of the document determined by the change-scope determination unit 101, the change-candidate determination unit 102 may set, for change candidates, priorities indicating the degrees of necessity of change which is to be made by a user. Additionally, in determination of change candidates in the other documents, the change-candidate determination unit 102 may set priorities for the change candidates on the basis of the hierarchical structure of the document. For example, in the change scope of the document determined by the change-scope determination unit 101 and the hierarchies contained in the change scope, the change-candidate determination unit 102 may set a higher priority for a change candidate determined on the basis of a lower hierarchy.

Specifically, the case in which the change scope of the document determined by the change-scope determination unit 101 contains multiple lower hierarchies containing parts actually changed by a user will be discussed. In this case, the change-candidate determination unit 102 may set, for a change candidate associated with a lower hierarchy containing a part changed by a user, a priority higher than the priority for a change candidate associated with a lower hierarchy which does not contain a part changed by the user.

In the example in FIGS. 4 and 5, the change-candidate determination unit 102 determines CHAPTER 1 of manual Y and CHAPTER 1 of manual Z as change candidates having priority higher than CHAPTER 2 of manual Y associated with TABLE 4C which does not contain a part changed by a user. CHAPTER 1 of manual Y is associated with TABLE 4A containing “consumption tax: xx %” which is a part changed by a user in manual X. CHAPTER 1 of manual Z is associated with TABLE 4D containing “fixed property tax: xx %”.

The change-candidate determination unit 102 outputs, to the change-candidate output unit 103, the determined change candidates as well as the priorities of the change candidates.

### The Process Performed by the Change-Candidate Output Unit 103

The change-candidate output unit 103 outputs, to the terminal apparatus 20, change candidates in the other documents which are determined by the change-candidate determination unit 102, and displays the change candidates in the other documents, for example, on the display device of the terminal apparatus 20.

In this example, the change-candidate output unit 103 displays, on the display device of the terminal apparatus 20, CHAPTER 1 of manual Y, CHAPTER 2 of manual Y, and CHAPTER 1 of manual Z as change candidates in the other documents.

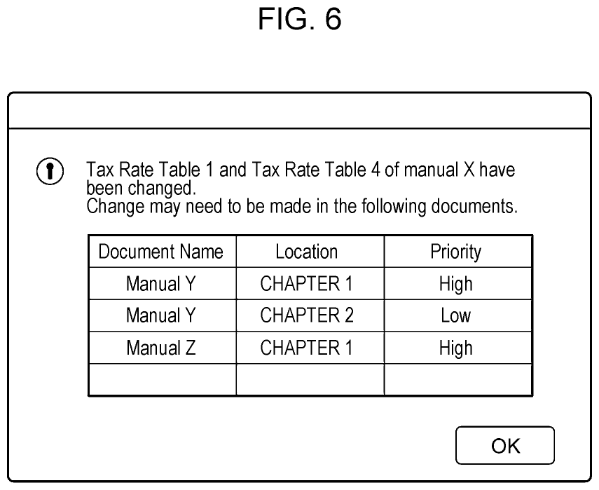

FIG. 6 is a diagram illustrating an exemplary display screen displayed on the display device of the terminal apparatus 20 on the basis of the output from the change-candidate output unit 103.

As illustrated in FIG. 6, a message, “Tax Rate Table 1 and Tax Rate Table 4 of manual X have been changed.” which indicates changed parts in manual X, is displayed on the terminal apparatus 20 on the basis of the output from the change-candidate output unit 103. CHAPTER 1 of manual Y, CHAPTER 2 of manual Y, and CHAPTER 1 of manual Z, which are change candidates determined by the change-candidate determination unit 102, are displayed on the terminal apparatus 20 on the basis of the output from the change-candidate output unit 103. Further, the priorities for changes to the change candidates determined by the change-candidate determination unit 102 are displayed on the terminal apparatus 20 on the basis of the output from the change-candidate output unit 103.

Thus, in the information processing system 1 (see FIG. 1) according to the first exemplary embodiment, a user or the like who has changed manual X by using the terminal apparatus 20 may know the scopes in manual Y and manual Z, to which changes may need to be made in relation to the change of manual X, on the basis of the change candidates displayed on the terminal apparatus 20.

### Second Exemplary Embodiment

A second exemplary embodiment of the present disclosure will be described. The same configurations as those in the first exemplary embodiment are designated with the same reference characters, and will not be described in detail.

In the first exemplary embodiment, when multiple parts are changed in a document having a hierarchical structure, the change-scope determination unit 101 of the information processing apparatus 10 determines, as a change scope, the lowest hierarchy which is the lowest among multiple hierarchies containing the changed parts. However, the process performed by the change-scope determination unit 101 is not limited to this.

When the lowest hierarchy containing multiple changed parts satisfies a predetermined condition, the change-scope determination unit 101 may regard, as a change scope, an upper hierarchy containing the lowest hierarchy. As an example of the case in which the lowest hierarchy satisfies the predetermined condition, the second exemplary embodiment describes, as an example, a form in which, when the lowest hierarchy is associated with an upper hierarchy, the lowest hierarchy is replaced with the upper hierarchy, and the upper hierarchy is regarded as a change scope.

In the information processing apparatus 10 according to the second exemplary embodiment, a replacement table, in which a hierarchy in a changed document is associated with an upper hierarchy that contains the hierarchy and that is a replacement target with which the hierarchy is replaced, is stored, for example, in the storage device 12.

When multiple parts are changed in a document having a hierarchical structure, the change-scope determination unit 101 obtains the replacement table, for example, from the storage device 12, and determines a change scope by using the replacement table. That is, when the lowest hierarchy containing multiple changed parts is associated with an upper hierarchy in the replacement table, the change-scope determination unit 101 replaces the lowest hierarchy with the upper hierarchy, and determines the upper hierarchy as a change scope.

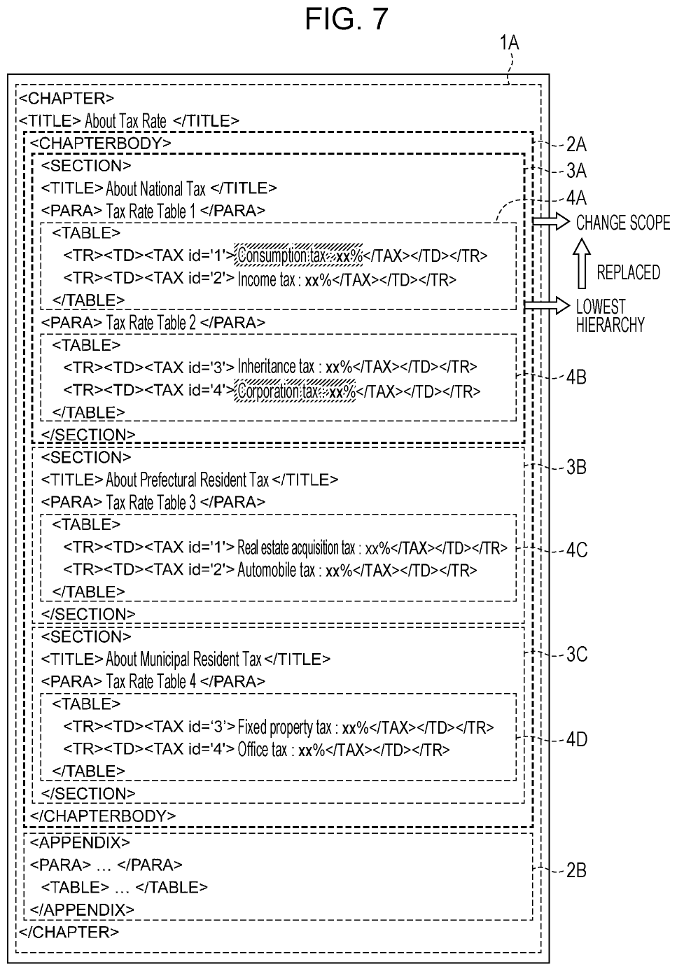

FIG. 7 is a diagram illustrating manual X which is an exemplary changed document obtained by the change-scope determination unit 101. Manual X in FIG. 7 has substantially the same hierarchical structure as that of manual X in FIG. 4 described in the first exemplary embodiment. In this example, it is assumed that, in manual X, “consumption tax: xx %” in TABLE 4A and “corporation tax: xx %” in TABLE 4B, which are illustrated with a hatched pattern in FIG. 7, are parts changed by a user by using the terminal apparatus 20.

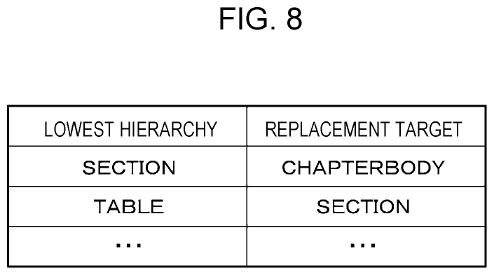

FIG. 8 is a diagram illustrating an exemplary replacement table obtained by the change-scope determination unit 101. In the replacement table illustrated in FIG. 8, a hierarchy, “SECTION”, is associated with “CHAPTERBODY” which is an upper hierarchy containing SECTION; a hierarchy, “TABLE”, is associated with “SECTION” which is an upper hierarchy containing TABLE.

In manual X as illustrated in FIG. 7, the lowest hierarchy among the hierarchies containing both “consumption tax: xx %” of TABLE 4A and “corporation tax: xx %” of TABLE 4B, which are changed parts, is SECTION 3A.

In the replacement table as illustrated in FIG. 8, a hierarchy, “SECTION”, is associated with “CHAPTERBODY” which is an upper hierarchy containing SECTION. Therefore, the change-scope determination unit 101 replaces SECTION 3A, which is the lowest hierarchy, with CHAPTERBODY 2A, which is associated with SECTION 3A in the replacement table and which is an upper hierarchy containing SECTION 3A, and determines CHAPTERBODY 2A as a change scope.

In the information processing apparatus 10, the change-scope determination unit 101 replaces the lowest hierarchy with an upper hierarchy, and regards the upper hierarchy as a change scope. Thus, compared with the case in which the lowest hierarchy is regarded as a change scope, more change candidates determined by the change-candidate determination unit 102 are easily obtained. Accordingly, compared with the case in which the lowest hierarchy is regarded as a change scope, this suppresses occurrence of the state in which parts, which are to be changed in the other documents, are left out from the change candidates.

The replacement table, which is used by the change-scope determination unit 101 in determination of a change scope, may be created, for example, by a user who changes a document by using the terminal apparatus 20.

Alternatively, the replacement table may be generated, for example, by the information processing apparatus 10, for example, on the basis of the change history for the documents stored in the change-history storage unit 106. In this case, compared with the case in which the replacement table is not generated on the basis of the change history, the change-candidate determination unit 102 easily lists, as change candidates, parts which are highly likely to be actually changed by a user in the other documents.

Specifically, for example, when the change history contains many changed parts of the other documents which were changed at the same time at which the document was changed, the information processing apparatus 10 generates the replacement table in which a further upper hierarchy among upper hierarchies containing the lowest hierarchy is associated as a replacement target.

The second exemplary embodiment describes the following case as an example in which, when the lowest hierarchy containing changed parts satisfies the predetermined condition, the change-scope determination unit 101 regards, as a change scope, an upper hierarchy containing the lowest hierarchy: in the replacement table or the like, the lowest hierarchy is associated with the upper hierarchy in advance. However, the configuration is not limited to this.

As the case in which the lowest hierarchy satisfies the predetermined condition, the change-scope determination unit 101 may regard, as a change scope, an upper hierarchy containing the lowest hierarchy when the content of the lowest hierarchy satisfies a predetermined condition.

Examples of the case in which the content of the lowest hierarchy satisfies the predetermined condition include the case in which the data amount, such as the number of characters or the number of images, contained in the lowest hierarchy is smaller than a predetermined amount. Additionally, when the data amount of the lowest hierarchy is too small, the change history may contain a small number of parts of the other documents which are associated with the lowest hierarchy. In this case, if the lowest hierarchy is determined as a change scope, insufficient change candidates determined by the change-candidate determination unit 102 may be obtained on the basis of the change history.

In contrast, when the data amount contained in the lowest hierarchy is smaller than the predetermined amount, the change-scope determination unit 101 regards, as a change scope, an upper hierarchy containing the lowest hierarchy. Thus, occurrence of the state in which insufficient change candidates are determined by the change-candidate determination unit 102 is suppressed.

### Third Exemplary Embodiment

A third exemplary embodiment of the present disclosure will be described. The same configurations as those in the first and second exemplary embodiments are designated with the same reference characters, and will not be described in detail.

In the second exemplary embodiment, when multiple parts are changed in a document having a hierarchical structure, if the lowest hierarchy containing the changed parts satisfies the predetermined condition, the change-scope determination unit 101 of the information processing apparatus 10 regards, as a change scope, an upper hierarchy containing the lowest hierarchy. However, the case in which the change-scope determination unit 101 regards an upper hierarchy as a change scope is not limited to this. When the content of change to a document satisfies a predetermined condition, the change-scope determination unit 101 may regard, as a change scope, an upper hierarchy containing the lowest hierarchy.

Examples of the case in which the content of change to a document satisfies a predetermined condition include the case in which the number of changed parts contained in the lowest hierarchy is equal to or larger than a predetermined number, the case in which, for example, the number of characters in the changed parts is equal to or larger than a predetermined number, and the case in which the degree of similarity between the changed parts exceeds a predetermined range. However, the configuration is not limited to this.

When the lowest hierarchy is contained in multiple upper hierarchies, the change-scope determination unit 101 may select an upper hierarchy determined as a change scope in accordance with the content of change to the document. For example, as the number of changed parts contained in the lowest hierarchy is larger, as the number of characters of the changed parts is larger, or as the difference between the degrees of similarity between changed parts is larger, the change-scope determination unit 101 may regard a further upper hierarchy as a change scope. Thus, compared with the case in which an upper hierarchy determined as a change scope in accordance with the content of change to the document is not selected, the change-candidate determination unit 102 easily lists, as change candidates, parts which are highly likely to be actually changed by a user.

### Fourth Exemplary Embodiment

A fourth exemplary embodiment of the present disclosure will be described. The same configurations as those in the first to third exemplary embodiments are designated with the same reference characters, and will not be described in detail.

As described above, when multiple parts are changed in a document having a hierarchical structure, the change-scope determination unit 101 determines, as a change scope, a hierarchy containing the changed parts. In the fourth exemplary embodiment, when a document has multiple hierarchies containing changed parts, the change-scope determination unit 101 determines, as a change scope, a hierarchy lower than a predetermined hierarchy.

The change-scope determination unit 101 may determine, as a change scope, a hierarchy lower than the predetermined hierarchy on the basis of the hierarchical structure of a document having multiple changed parts. For example, when the uppermost hierarchy containing multiple changed parts in a document is the entire document, the change-scope determination unit 101 determines, as a change scope, a hierarchy lower than the uppermost hierarchy.

When a change scope determined by the change-scope determination unit 101 is a too upper hierarchy such as the entire document, the change-candidate determination unit 102 may determine too many change candidates on the basis of the change scope. In this case, other documents, which do not need to be changed in relation to changes to the document, are easily determined as change candidates.

In contrast, in the fourth exemplary embodiment, the change-scope determination unit 101 determines, as a change scope, a hierarchy lower than the predetermined hierarchy. Thus, it is difficult for the change-candidate determination unit 102 to determine, as change candidates, other documents which do not need to be changed.

The change-scope determination unit 101 may determine, as a change scope, a hierarchy lower than the predetermined hierarchy on the basis of change candidates in the other documents, which are determined by the change-candidate determination unit 102 on the basis of the change scope of the document. Specifically, the change-scope determination unit 101 obtains, from the change-candidate determination unit 102, temporary change candidates, which are determined by the change-candidate determination unit 102 when each hierarchy containing the changed parts is assumed to be a change scope. On the basis of the temporary change candidates determined corresponding to each hierarchy, the change-scope determination unit 101 determines, as a change scope, a hierarchy in which the number of change candidates falls within a predetermined range.

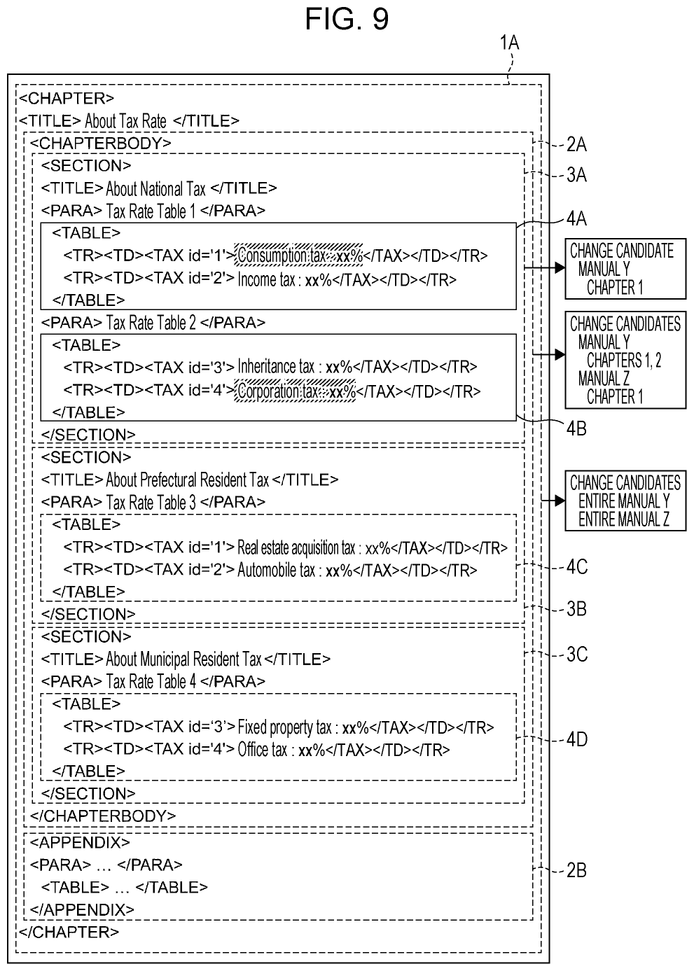

FIG. 9 is a diagram for describing the process performed by the change-scope determination unit 101 according to the fourth exemplary embodiment, and is a diagram illustrating exemplary temporary change candidates determined in manual X. In this example, manual X has changed parts, which are changed by a user by using the terminal apparatus 20, of “consumption tax: xx %” of TABLE 4A and “corporation tax: xx %” of TABLE 4B which are illustrated with a hatched pattern in FIG. 9.

As illustrated in FIG. 9, manual X contains CHAPTER 1A, CHAPTERBODY 2A, and SECTION 3A as hierarchies containing both “consumption tax: xx %” of TABLE 4A and “corporation tax: xx %” of TABLE 4B which are changed parts.

In this example as illustrated in FIG. 9, when CHAPTER 1A of manual X is assumed to be a change scope, temporary change candidates determined by the change-candidate determination unit 102 are “the entire manual Y” and “the entire manual Z”. When CHAPTERBODY 2A of manual X is assumed to be a change scope, temporary change candidates determined by the change-candidate determination unit 102 are “CHAPTER 1, 2 of manual Y” and “CHAPTER 1 of manual Z”. When SECTION 3A of manual X is assumed to be a change scope, the temporary change candidate determined by the change-candidate determination unit 102 is only “CHAPTER 1 of manual Y”.

The change-scope determination unit 101 determines, as a change scope, a hierarchy of manual X, for which the number of temporary change candidates falls within the predetermined range, on the basis of the temporary change candidates determined by the change-candidate determination unit 102.

Thus, the change-scope determination unit 101 determines a change scope on the basis of change candidates in the other documents. This suppresses occurrence of the state in which, due to a too narrow change scope, the change-candidate determination unit 102 fails to list change candidates, or the state in which, due to a too wide change scope, other documents, which do not need to be changed, are determined as change candidates.

In the exemplary embodiments described above, the case in which both a document, which is changed by a user and for which a change scope is determined by the change-scope determination unit 101, and other documents, which are determined as change candidates by the change-candidate determination unit 102 on the basis of the change scope, have hierarchical structures is described as an example. However, as long as at least a document, which is changed by a user and for which a change scope is determined by the change-scope determination unit 101, has a hierarchical structure, the other documents do not necessarily have hierarchical structures.

The exemplary embodiments are described above. The technical scope of the present disclosure is not limited to the scope described in the exemplary embodiments. It is apparent, from the claims, that embodiments, to which various changes and improvements are added to the exemplary embodiments, are also encompassed in the technical scope of the present disclosure.

What is claimed is:

1. An information processing apparatus comprising:
a processor configured to:
in response to change to a plurality of parts in a document having a hierarchical structure, regard, as a change scope, a hierarchy containing the plurality of parts, and determine a change candidate that is to be changed in another document different from the document.

2. The information processing apparatus according to claim 1,
wherein the processor is configured to regard, as the change scope, a lowest hierarchy which is the lowest among hierarchies containing the plurality of parts.

3. The information processing apparatus according to claim 2,
wherein the processor is configured to, when the lowest hierarchy satisfies a predetermined condition, regard, as the change scope, an upper hierarchy containing the lowest hierarchy.

4. The information processing apparatus according to claim 3,
wherein the processor is configured to, when the lowest hierarchy is associated with the upper hierarchy in advance, regard the upper hierarchy as the change scope.

5. The information processing apparatus according to claim 4,
wherein the lowest hierarchy is associated with the upper hierarchy on a basis of a past change history for the document and the other document.

6. The information processing apparatus according to claim 2,
wherein the processor is configured to, when content of change to the document satisfies a predetermined condition, regard, as the change scope, an upper hierarchy containing the lowest hierarchy.

7. The information processing apparatus according to claim 6,
wherein the processor is configured to, when the upper hierarchy is one of a plurality of upper hierarchies containing the lowest hierarchy, select, in accordance with the change to the document, the upper hierarchy regarded as the change scope.

8. The information processing apparatus according to claim 1.
wherein the processor is configured to, when there are a plurality of hierarchies containing the plurality of parts, regard, as the change scope, a hierarchy lower than a predetermined hierarchy.

9. The information processing apparatus according to claim 8,
wherein the processor is configured to select a hierarchy regarded as the change scope, on a basis of the hierarchical structure of the document.

10. The information processing apparatus according to claim 8,
wherein the processor is configured to select a hierarchy regarded as the change scope, on a basis of the change candidate determined on a basis of the change scope.

11. The information processing apparatus according to claim 1,
wherein the processor is configured to:
on a basis of a past change history for the document and the other document, set a part in the other document as the change candidate, the part in the other document being associated with the change scope of the document; and
in the change scope of the document, set a higher priority of a user's change for a first change candidate than for a second change candidate, the first change candidate being associated with a lower hierarchy containing the changed parts in the document, the second change candidate being associated with a lower hierarchy which does not contain the changed parts.

12. A non-transitory computer readable medium storing a program causing a computer to execute a process comprising:
in response to change to a plurality of parts in a document having a hierarchical structure, regarding, as a change scope, a hierarchy containing the plurality of parts, and determining a change candidate that is to be changed in another document different from the document.

13. An information processing method comprising:
in response to change to a plurality of parts in a document having a hierarchical structure, regarding, as a change scope, a hierarchy containing the plurality of parts, and determining a change candidate that is to be changed in another document different from the document.
